(19) United States
(12) Patent Application Publication
(10) Pub. No.: US 2007/0274530 A1
(43) Pub. Date: Nov. 29, 2007

(54) Audio Entertainment System, Device, Method, And Computer Program

(75) Inventors: Vincentius Paulus Buil, Eindhoven (NL); Gerrit Hollemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,563

(22) PCT Filed: Mar. 25, 2005
(86) PCT No.: PCT/IB05/51034

§ 371 Date: Oct. 2, 2006

(30) Foreign Application Priority Data
Apr. 5, 2004 (EP) 04101398.8

(51) Int. Cl. H04R 1/10

(52) U.S. Cl. 381/74

(57) ABSTRACT

An audio entertainment system (100) comprises: a set of earpieces (101) for transducing audio (102), with a first earpiece (103) having a first input means (104) for receiving input (113) to control (106) the transducing; and a first detector (107) for detecting the first earpiece (103) being positioned (108) for transducing audio (102). The audio entertainment system (100) is arranged to enable (109) control (106) with the first input means (104) only after a predetermined first period (110) in which the first earpiece (103) is detected, with the first detector (107), to be continuously positioned for transducing audio (102). This prevents accidental operation of e.g. a media player with the input means (104) while e.g. inserting the first earpiece (103).

The invention relates to an audio entertainment system comprising:
a set of earpieces for transducing audio, with a first earpiece having a first input means for receiving input to control the transducing; and
a first detector for detecting the first earpiece being positioned for transducing audio.

The invention also relates to a device, a method and a computer program product for use in such a system.

An example of a system as described in the opening paragraph is described in the non-prepublished European patent application 03101081.2 (PHNL030392). Said patent application describes an audio entertainment system with an audio device and two earpieces for transducing audio. A first earpiece has a controller with input means for controlling the audio device. The input means have a touch-sensitive area. Based on a detection of the touch-sensitive area being touched, the audio device is controlled by means of a control signal sent from the controller to the audio device. This prevents the hassle involved in finding, manipulating and operating a conventional control that is typically dangling somewhere along a wire. The patent application also describes how to prevent accidental control actions. The earpiece may therefore have a further touch-sensitive area which makes contact with the skin when the earpiece is being worn in or by the ear. The earpiece only sends the control signal if the further touch-sensitive area makes contact.

It is a drawback of the system described in the patent application that an inadvertent input for controlling the transducing is still likely to occur frequently, because the input means are likely to receive input at the time of inserting or positioning the earpiece. Due to the relatively small part by which to hold the earpiece when inserting it or taking it out, and due to the touch-sensitive area covering a relatively large portion of the part, it may be hardly possible to position the earpiece without providing an input.

It is an object of the invention to provide a system of the type described in the opening paragraph that reduces the risk of inadvertently controlling the transducing of the audio.

The object is realized in that the system is arranged to enable control with the first input means only after a predetermined first period in which the first earpiece is detected, with the first detector, to be continuously positioned for transducing audio.

By enabling the control only after the predetermined first period, inadvertent control is not possible during the first period. This measure is particularly effective, because inadvertent control would be likely to occur during the first period without taking this measure. In other words, with an appropriately predetermined first period, the risk of inadvertently controlling the audio production is substantially reduced.

To a certain extent, the invention is based on the recognition that positioning the earpieces takes a while, and that the user is typically satisfied with the position before the predetermined first period lapses.

The audio entertainment system may further comprise other input means or other output means, for example, a video display, a game pad, or a keyboard. The audio entertainment system may comprise or be part of e.g. a gaming device, a communication device, a computing device, a personal digital assistant, a smartphone, a portable computer, a palmtop, a tablet computer, or an organizer.

The audio transduced may be generated in the audio entertainment system, for example, by playing it from a medium, e.g. an optical disk such as a BluRay disc, a DVD, a CD, a hard-disc, a solid-state memory. The audio transduced may alternatively or additionally be received by the audio entertainment system, for example, via a wireless interface, e.g. a wireless LAN, WiFi, UMTS, or via a wired interface, e.g. USB, FireWire, or via another interface.

The first earpiece may be an in-ear type of headphone or earpiece, a headset with a boom, a headband with a cup, or another type of earpiece or headphone.

The first earpiece has a first input means for receiving input to control the transducing. The first input means may be, for example, an electromechanical sensor, e.g. a switch, a button, an electronic sensor, e.g. a touch sensor, an electro-optical sensor, e.g. an infrared sensor, or a laser beetle. The first input means may also be a speaker that transduces the audio, used as a microphone. Tapping the earpiece causes a particular noise, which may be picked up by the speaker, causing an electric signal, e.g. on terminals of the speaker. The signal may be detected by means of a detector for the particular noise. The detector is electrically coupled to the speaker.

The input received may be e.g. a switch-over, a push, a tap, a press, a movement, or a noise.

The controlling may be e.g. increasing or decreasing a setting, for example, an audio volume, an audio balance, a tone color, or any setting for an audio effect like reverberation, chorus, etc. The control action may pertain to the audio, for example, selecting an audio source, e.g. an artist, an album, a track, a position in time of a track, or a playback speed.

The audio may be transduced by means of an electro-acoustic transducer like a voice coil speaker, a piezo speaker, a membrane speaker, or another speaker, but the audio may also be transduced by guidance to the ear through a tube.

The audio entertainment system comprises a first detector for detecting the first earpiece being positioned for transducing audio. The first detector may be based on an operating principle like, for example, closing an electric circuit between a pair of e.g. skin contacts, or spring switch contacts, detecting an infrared radiation, detecting the presence of an earlobe, or another operating principle.

The audio entertainment system is arranged to enable control with the first input means only after a predetermined first period in which the first earpiece is detected, with the first detector, to be continuously positioned for transducing audio.

This may be implemented in several ways. In a first way, the audio entertainment system comprises a timer. The timer is started to count from zero as soon as the earpiece is detected to be positioned for transducing audio. The timer is reset to zero as soon as the earpiece is no longer detected to be positioned for transducing audio. When the timer achieves a value corresponding to the first period, the timer triggers the enabling. In a second way, the timer may count down from the value of the first period to zero and is reset to the value of the first period. In a third way, the audio entertainment system comprises a delay element rather than a timer. A signal like a step or pulse is applied to an input of the delay element when the earpiece is detected to be positioned for transducing audio. The delay element triggers the enabling operation when the step or pulse arrives at an output of the delay element. The delay element is emptied as soon as the earpiece is no longer detected to be positioned for transducing audio. Other ways are also possible. Similarly, there are several ways to disable control of the transducing action. Some enabling modes may be implemented partially or as a whole by means of instructions to a computer processor.

The first period is advantageously chosen to be within a range from 100 milliseconds to 2 seconds, with 1 second being a favorable choice.

In an embodiment, the audio entertainment system has the features of claim 2. The second earpiece may be similar to the first earpiece. The first and the second earpiece may be used as a pair for transducing respective audio, e.g. a stereo sound. This further reduces the risk of inadvertently controlling the audio production.

In another embodiment, the audio entertainment system has the features of claim 3. This still further reduces the risk of inadvertently controlling the audio production, because both the first and the second earpiece are now required to have been positioned continuously for respective periods. The first and the second period may be chosen to be equally long.

In another embodiment, the audio entertainment system has the features of claim 4. This measure reduces the risk of inadvertently controlling the audio production even further. The measure is based on the recognition that the first input means are likely to receive an input during the positioning operation, and that an end to such an input is likely to indicate the end of the positioning operation.

In another embodiment, the audio entertainment system has the features of claim 5. This measure also reduces the risk of inadvertently controlling the audio production. The measure is based on the recognition that the first and the second earpiece are typically positioned or inserted substantially simultaneously, and that positioning e.g. the second earpiece increases the likelihood of the first earpiece being repositioned, although the first period has lapsed.

In another embodiment, the audio entertainment system has the features of claim 6. This measure also reduces the risk of inadvertently controlling the audio production. The measure is based on the recognition that the first and the second earpiece are typically taken off or extracted substantially simultaneously, and that such an input is likely to indicate an end to a period in which the earpieces were positioned for transducing audio.

In another embodiment, the audio entertainment system has the features of claim 7. This measure reduces the risk of inadvertently controlling the audio production too, and is based on the recognition that an input may be inadvertent if the first earpiece is taken off, remote, or extracted, from the ear.

The above object and features of the audio entertainment system, the method and the computer program product of the present invention will be more apparent from the following description with reference to the drawings.

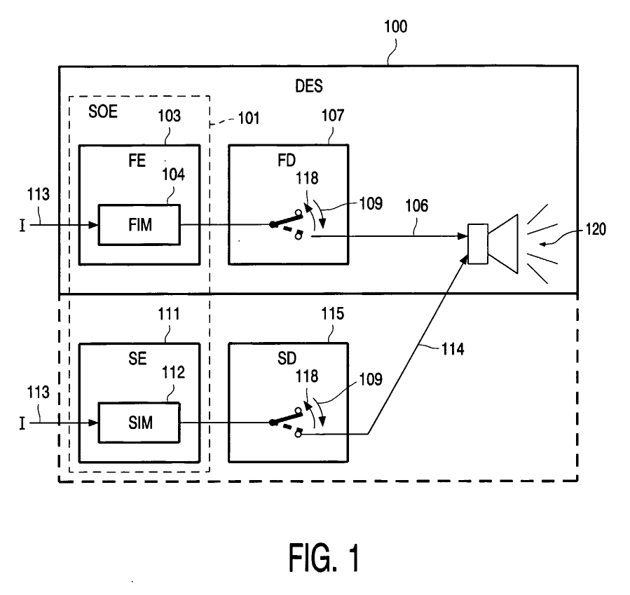

FIG. 1 shows a block diagram of an audio entertainment system 100 according to the invention.

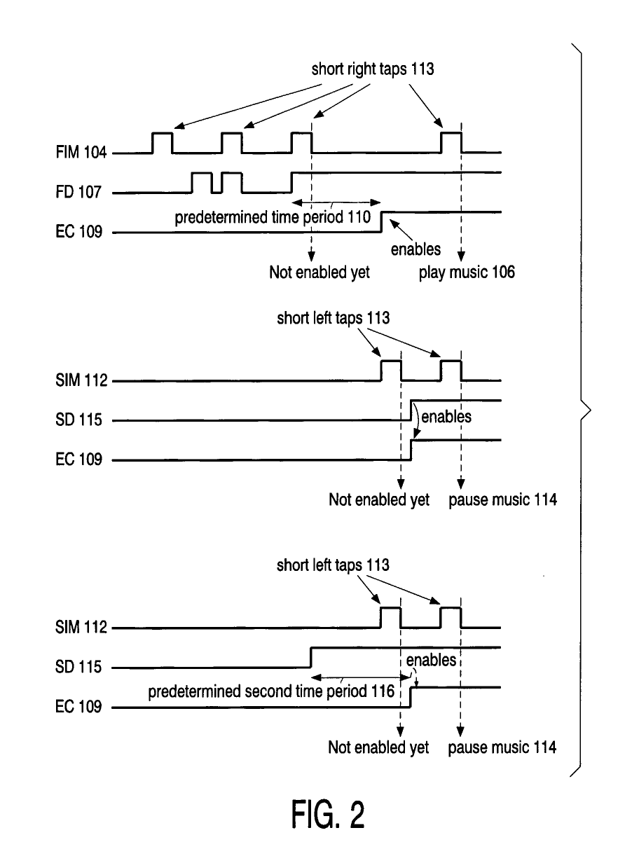

FIG. 2 shows a timing diagram of the operation of an earpiece 103 according to the invention.

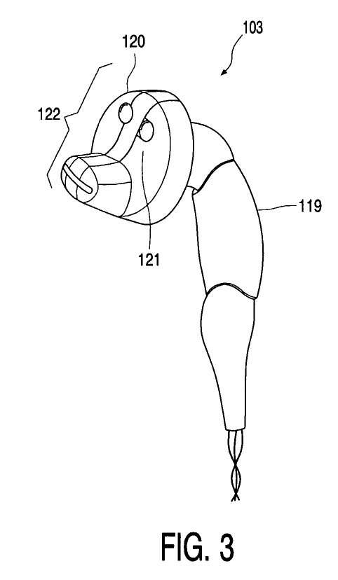

FIG. 3 shows a close-up of touch areas 119, 120, 121, 122 of an earpiece 103 according to the invention.

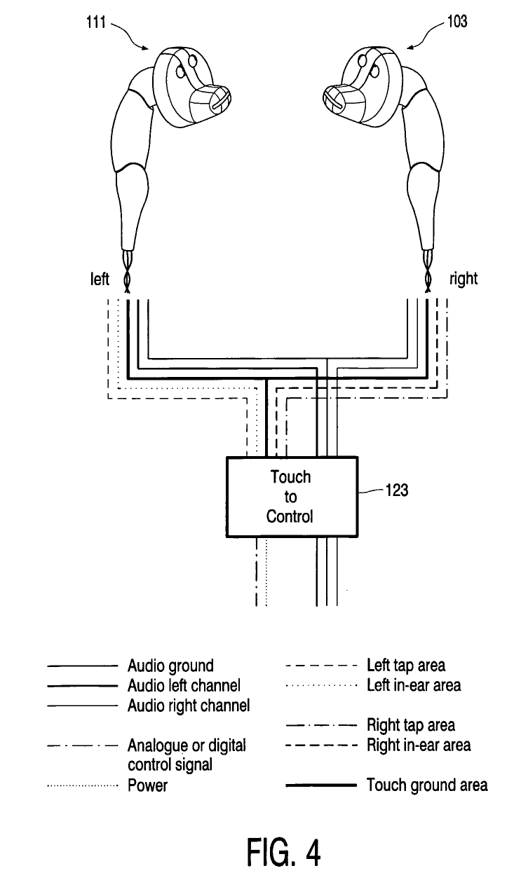

FIG. 4 shows an example of wiring the headphones 103, 111 according to the invention.

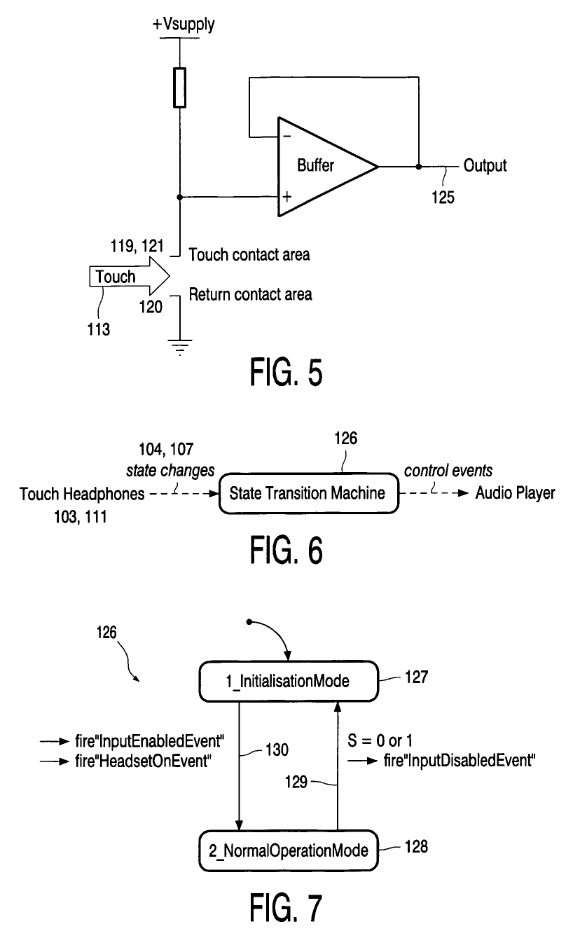

FIG. 5 shows a schematic example for touch-sensing.

FIG. 6 shows an overview of a state transition machine 126 for a touch headphone 103, 111 according to the invention.

FIG. 7 shows internals of a state transition machine 126 for a touch headphone 103, 111 according to the invention.

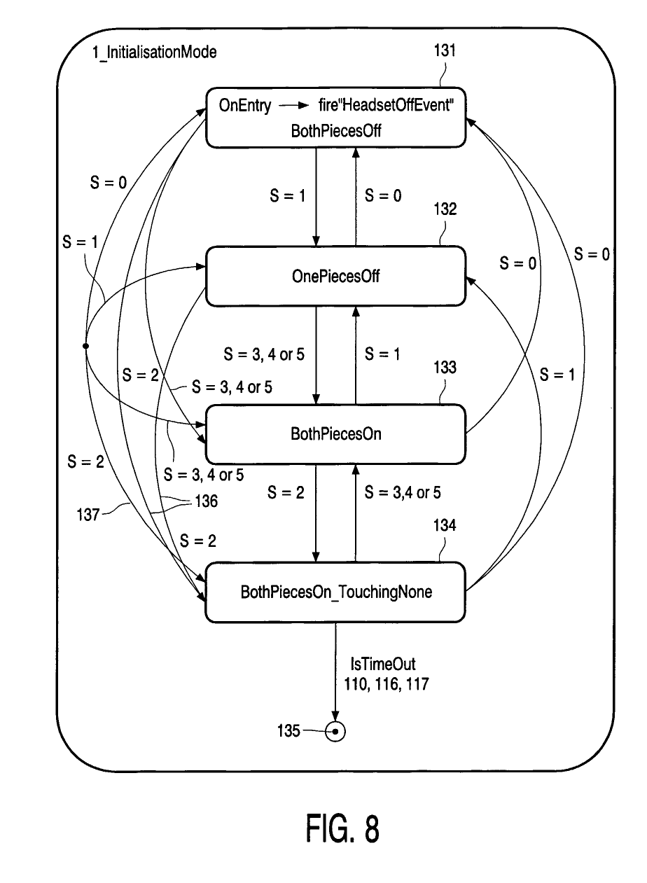

FIG. 8 shows a state diagram for internals of the state 127 1_InitialisationMode.

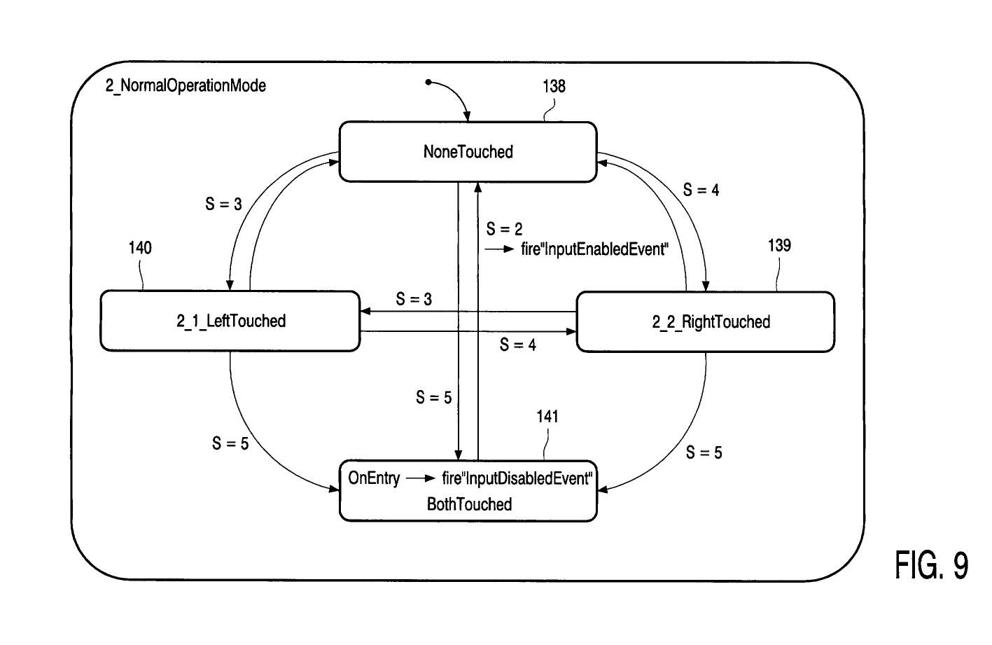

FIG. 9 shows a state diagram for internals of the state 128 2_NormalOperationMode.

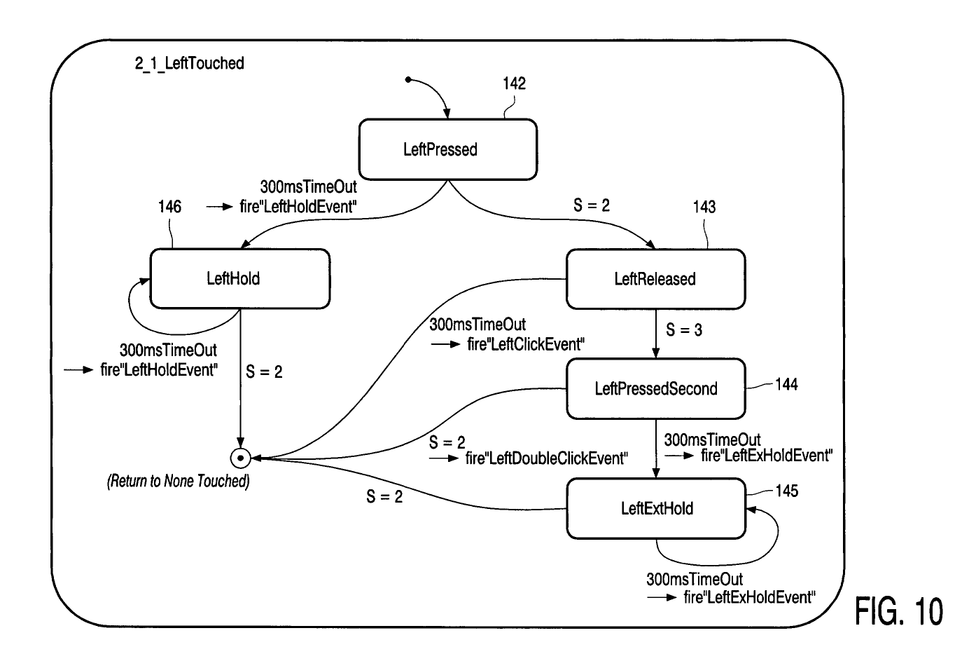

FIG. 10 shows a state diagram for internals of the state 140 2_1_LeftTouched.

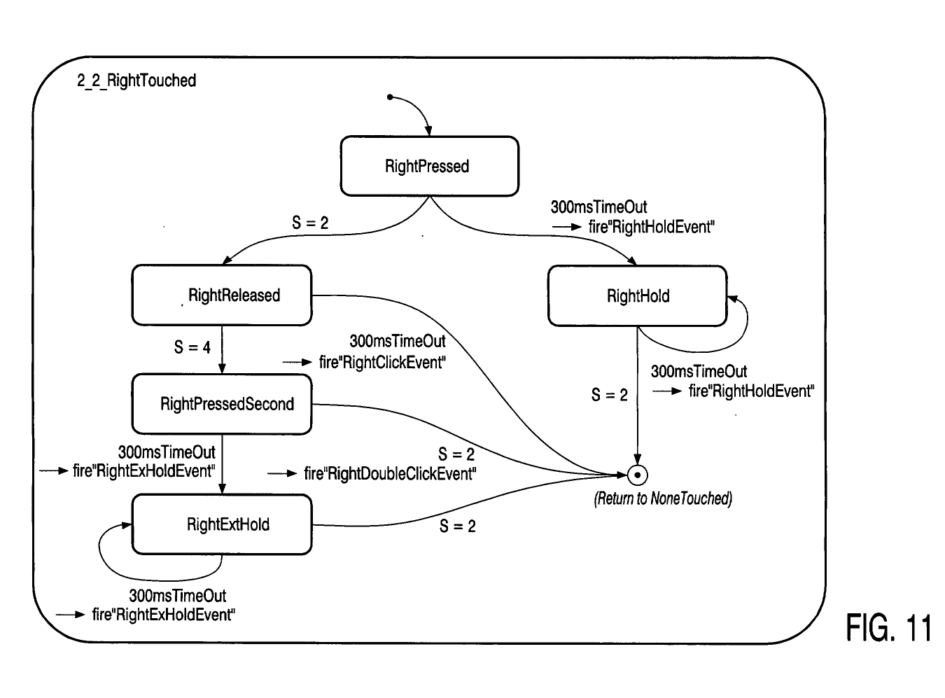

FIG. 11 shows a state diagram for internals of the state 139 2_2_RightTouched.

In the described embodiments, the audio entertainment system 100 comprises a portable audio player, a set of earpieces 101 for transducing the audio 102 from the player, with a first earpiece 103 having a first input means 104. In this embodiment, the set of earpieces 101 is also referred to as headset or headphone, but it may comprise several headphones for sharing audio in a group of people. The first input means 104 comprises a touch-sensitive area 119 on the earpiece 103. The touch-sensitive area 119 may receive input 113 for controlling 106 the player, which adapts the audio transduced accordingly. The input 113 is also referred to as touching, tapping, and tapping action. The first earpiece 103 has a first detector 107. In this embodiment, the first detector 107 comprises a further touch-sensitive area 122 with a pair of skin contacts 120, 121. If the first earpiece 103 is positioned 108 for transducing audio, i.e. if the earpiece 103 is inserted or worn by the ear, the skin closes an electric circuit by contacting the contacts 120, 121. An electric resistance may be measured between the contacts 120, 121 for detecting the first earpiece 103 being positioned for transducing audio. The audio entertainment system 100 is arranged to enable 109 control 106 with the first input means 104 only after a predetermined first period 110 in which the first earpiece 103 is detected, with the first detector 107, to be continuously positioned for transducing audio 102.

This is shown in the upper part of FIG. 2, wherein time flows from left to right, and wherein the relative heights of the lines indicate whether the first input means 104 receives an input 113, whether the first detector 107 detects the positioning of the earpiece 103 for transducing audio, and whether the control action 106 is enabled, respectively. Only after the first detector 107 has detected the first earpiece 103 to be positioned for transducing audio for the predetermined first period 110, the input 113 on the first input means 104 results in a control action 106 of the audio player.

This behavior may be achieved by means of a timer coupled to disabling means. The timer may be located in, for example, the earpiece 103, or in the audio player. In the embodiment described below, the timer is implemented in software with a routine in accordance with the described state diagrams in the Figures, as detailed further below.

As shown in the Figures, the audio entertainment system 100 may comprise a second earpiece 111. The second earpiece 111 comprises a second input means 112 for receiving input 113 to further control 114 the transducing action. The second earpiece 111 also comprises a second detector 115 for detecting the positioning 108 of the second earpiece 111 for transducing audio 102.

As shown in the middle part of FIG. 2, wherein the relative heights of the lines indicate whether the second input means 112 receives an input 113, whether the second detector 115 detects the positioning of the earpiece 111 for transducing audio, and whether the control action 106 and the further control action 114 are enabled 109, respectively, the system 100 may be further arranged to enable 109 control 106 and further control 114 only if, in addition, the second earpiece 111 is detected, with the second detector 115, to be positioned for transducing audio 102.

As shown in the lower part of FIG. 2, the system 100 may be further arranged to postpone enabling of the controlling 106 and the further control 114 until the second earpiece 111 has been detected, with the second detector 115, to be continuously positioned for transducing audio 102 for a predetermined second period 116.

In the embodiment in FIG. 4, the first and the second earpiece fit naturally in a right and a left ear, respectively, because of a substantial mirror symmetry between the first and the second earpiece. Alternatively, the first and the second earpiece may be substantially identical.

The system 100 may be further arranged to postpone enabling of the control action 106 and the further control action 114 until both the first and the second input means 112 are simultaneously without input 113. The system 100 may be further arranged to postpone enabling of the control action 106 and the further control action 114 until both the first and the second input means 112 have simultaneously been without input 113 for a predetermined third period 117. The system 100 may be further arranged to disable 118 the control action 106 and the further control action 114 if both the first and the second input means 112 receive input 113 simultaneously. The system 100 may be further arranged to disable 118 the control action 106 with the first input means 104 as soon as the first earpiece 103 is detected to be no longer positioned for transducing audio 102.

The invention may be applied, for example, for operating the deck-controls (play, pause, next, etc.) of a portable audio player via touch controls 119 on the headphones 103, 111.

The mapping of the user's tapping on the earpieces 103, 111 to actions of the player may follow two user interface design rules: (1) frequently used functionality should be easily accessible, and (2) follow the Western convention of left to decrease and right to increase values. In line with these rules, the mapping of the different tapping patterns 113 onto the player's deck and volume controls may be done as described in Table 1. Investigation indicates that people find this mapping intuitive and easy to learn.

TABLE 1
Example of mapping tapping patterns to deck and volume controls

| Tapping | Function on left | Function on right |
|---|---|---|
| pattern | earpiece | earpiece |
| Single tap | Pause | Play |
| Double tap | Previous track | Next track |
| Hold | Volume down | Volume up |
| Tap-and-hold | Fast rewind | Fast forward |

Another possibility is to map a single tap 113 on either earpiece 103, 111 to a toggle that alternates between a first state of playing and a second state of pausing. This has the advantage that both functions of pausing and playing are available at both earpieces 103, 111. This measure provides greater convenience of invoking both functions with one hand with this mapping.

Besides the tapping, another automatic control function may be offered by the touch headphone. When the headphone 103, 111 is taken off, the player may automatically pause playback, and when the headphone 103, 111 is put on, playback may automatically start, optionally resuming from the position where it paused. This is convenient, because it may avoid battery depletion when the user is not listening. Additionally, it may prevent the user missing a part of the music, for example, when talking briefly to someone in the street.

Augmentation of a regular headphone used with the latest portable audio players with touch controls requires several modifications. First of all, the headphone itself needs to be modified to become touch-sensitive, which requires some electro-technical and mechanical engineering. Secondly, the touch actions should be translated into a signal that can easily be interpreted by the player. Finally, these signals should be analyzed for tapping patterns to initiate the corresponding actions of the player. The whole set-up has a few logic components, mechanical modifications of an in-ear type headphone and electronic components.

Components

Five logic components may be used to realize a touch-enabled in-ear type headphone. These five components, A to E, form the chain needed to sense the tapping actions, translate them into analog electric signals, then digitize these signals, analyze the tapping patterns, and finally send out control signals to the audio player. We have set out these five components below. The choice of location of certain components may depend on design choices, like the manufacturing context and connectivity to existing products.

A. The touch-sensing action may be performed via conductive areas on the headset.

B. The touch signals may be buffered, which may be done by means of e.g. high-impedance electronics.

C. The buffered signals (0-2.5 Volt) may be digitized and fed into a processing subsystem 100 via a data acquisition card.

D. The processing subsystem 100 may measure voltage changes, and may convert the changes into control events (play, next, volume up, etc.) for the player.

E. The player responds to the control events.

Six touch-sensitive areas on an in-ear type headset may be used, composed of 3 areas 119, 120, 121 per earpiece, as depicted in FIGS. 3 and 4. The area 119 is used to control the player, the areas 120 and 121 are used to detect if the headset is being worn. Detection of whether the headset is being worn may be utilized to achieve robustness withstanding accidental touch of the touch-sensitive areas 119.

The areas are:

1. Ground area 120: this area is used to detect closing of an electric circuit via area 119 or 121. This may be the ground terminal of the audio signal.

2. In-ear detection area 121: when the earpiece is inserted in the ear, skin contacts this area as well as the ground area 120, which may be detected by measuring a resistance and monitoring a change in the resistance measured.

3. Tap detection area 119: when the earpiece is touched by a finger, this area 119 is connected to ground area 120, via finger skin contacting this area 119 through the body to the ear skin contacting the ground area 120.

The touch areas 119, 120, 121 are designed with care, to avoid contacting skin undesirably. The ground area 120 and the in-ear detection gap 122 should be sufficiently large and positioned in such a way that a good contact is obtained if the earpieces are inserted in the ear. Furthermore, the tap detection area 119 should be sufficiently large to be easily touched by the finger, and positioned in such a way that accidental contact of this area 119 with the user's ear shell is avoided, because this may result in unintended actions.

Each earpiece 103, 111 may have its own in-ear detection area 121 and its own ground area 120, to be able to detect whether the user is wearing no earpieces, only one earpiece, or both earpieces 103, 111. In this way, robustness withstanding accidental touch when the headphone 103, 111 is not worn (e.g. when stored in a user's pocket) may be improved. The player may be arranged to only react to touch commands 113 when both earpieces 103, 111 are actually inserted.

When having the ground area 120 on only one earpiece 103 and an in-ear detection area 121 on the other earpiece 111, it is impossible to detect when the earpiece 103 with the ground area 121 is taken out of the ear. Thus, it is impossible to disable 118 the touch controls 119 at that moment, causing uncontrolled behavior as the ground 120 connection has fallen away.

Adding touch-sensitive areas 119 to the headphone may require extra wires next to the audio lines. A total number of five wires may run down from each earpiece 103, 111 onto the point 123 where the wires come together. At this point 123, the touch events 113 may be converted into some analog or digital control signal to minimize possible disturbance of e.g. a mobile phone, as is further explained below. Furthermore, the touch-sensing electronics that buffer the signal may need some power at this point 123. Instead of an extra power line, the power may be ‘added’ to the audio signal and ‘subtracted’ again with capacitors at the ‘touch to control converter’ with relatively simple electronics.

The relatively large size of capacitors may be a drawback. A wiring example is depicted in FIG. 4. A certain degree of shielding may be required for the different lines, to avoid disturbance of other devices. Separate ground lines may be used for the audio and the touch sensors. Alternatively, one ground line for both the audio and the touch-sensing may be used.

Touch Events to Control Signals

In a first touch-sensing principle, the resistance of a part of the human body is measured via contact areas 119, 120, 121 of conducting material. Here, typically the resistance between a finger and an ear or a head may be measured. When, for example, a finger touches the contact area 119 of the device 103, the resistance may exist between this area 119 and the return contact area 120 that contacts the ear or the head. This resistance may be measured with a voltage divider 124, see FIG. 5. In the untouched situation, the output voltage 125 of the divider 124 will be the supply voltage. Upon touching, the voltage 125 will decrease. The touch 113 may therefore be detected by measuring the voltage change 125.

The touch signals coming from the electronics described above typically have a relatively low power level. Therefore, the low-power signals may be converted into signals with a higher power level, which may subsequently be interpreted by the portable audio player. Because the low-power level touch signals may be susceptible to disturbance by a magnetic field from e.g. a GSM phone, or a microwave oven, the conversion is preferably performed close to the earpieces 103, 111. An example of such a position is in a ‘bud’ at the point 123 where the wires of the two earpieces 103, 111 come together. There are several options for processing the signal before offering it to the player. The most suitable option depends on the location of a certain processing logic.

Send Touch Signals Directly to Player

A first option is to perform most of the processing in the player. The weak signals coming from the touch detection areas 119, 120, 121 are directly transported to the player, where they are buffered, interpreted, etc. The headphone executes step A, while steps B to E are executed in the player. Compatibility with the Philips standard remote control may be provided with a separate connector, because the signals from the touch detection areas differ from the resistor values of a standard remote control. This option may be relatively sensitive to disturbances by other equipment as mentioned above.

Convert Touch Signals to Standard Resistor Values

A second option is to convert the four touch commands into standard resistor values before providing them to the player. The standard resistor values are defined in the Philips mobile remote control standard. The headphone 103, 111 executes steps A and B. The resistor values are interpreted in the audio player. The portable audio player may be backward compatible with the existing Philips standard remote control. The player preferably reacts differently to the signals from the touch headphone 103, 111 than to the signals from the standard remote control. When a standard remote control is plugged in, there is a direct mapping of resistor values to playback controls (e.g. 10 K Ohm means play, 20 K Ohm means next, etc.). However, when the touch headphone 103, 111 is plugged in, this direct mapping cannot be used, as the in-ear detection and the temporal tapping patterns need to be interpreted before they can be mapped to the playback controls. This interpretation logic may be in the player, and will be described in detail hereinafter.

TABLE 2
Example of mapping touch detection areas to resistor values

| Touch events | Resistor value |
|---|---|
| Left in-ear area | 10 K Ohm |
| Right in-ear area | 20 K Ohm |
| Left tapping area | 42 K Ohm |
| Right tapping area | 75 K Ohm |

The touch detection areas of the touch headphone may be mapped to the standard resistor values as described in Table 2. The resistor values in the Philips mobile remote control standard are such that any combination of multiple simultaneously pressed keys may be distinguished, by simply adding the respective resistor values. This means that in our example it is possible to e.g. detect a tap on the left earpiece while the earpieces are worn by the user, by detecting the value 10+20+42=72 K Ohm. For processing the actions with the touch headphone—headphone on/off, tapping—five combinations of these resistor values as listed in Table 3 are interesting.

TABLE 3
Example of touch combinations to be detected by the application

| | Voltage/resistance |
|---|---|
| Touch events | level |
| None in-ear | — |
| One in-ear | 10 or 20 K Ohm |
| Both in-ear + none touched | 30 K Ohm |
| Both in-ear + left touched | 72 K Ohm |
| Both in-ear + right touched | 95 K Ohm |
| Both in-ear + both touched | 147 K Ohm |

The player may distinguish coupling to a standard remote control from coupling to a touch headphone 103, 111, to adapt its processing. A first method is to put the resistor values for the touch headphone in another range, for example, by adding, say, 200 KOhm to all values given in Table 2 and Table 3. A standard remote control would then produce values below 200 KOhm, and the touch headphone would then produce values in the range above 200 KOhm. An open circuit or infinite resistance is the same for both and means that none is touched. A second method is to provide some mechanical switch to tell the player which remote control is plugged in.

Converting Interpreted Touch Patterns to Standard Resistor Values

A third option is to incorporate the interpretation logic in the touch headphone 103, 111, and as such have the headphone produce resistor values that can be directly mapped onto the playback controls. With this option, the processing steps A to D are executed in the headphone. The touch headphone may be compatible with the Philips remote control standard and its output may be mapped onto the playback controls in the same way. Therefore, this option may result in the touch headphone being forward compatible to any audio player that complies with the standard.

With this option, it may not be so easy to implement the automatic pause and resume function when putting on the headset. The Philips remote control standard uses a single resistor value of 10 K Ohm to toggle between playing and pausing. A separate play command and a separate pause command with two different resistor values are not part of the standard. One can only put a 10 K Ohm resistance on the control line for a short time to tell the player to (1) start playing when it was not, or (2) stop playing when it was. Sending this 10 K Ohm resistance when putting the headset either on or off would easily do the opposite of what is desired: if the player is paused and the headset is put off, it will start playing (thus depleting the batteries, and vice versa. As it may be hard to detect the current playing state of the player at the headphone, it may be hard to implement a reliable automatic pause and resume function based on putting the headset on and off with this option.

Consequences for Wiring and Power Supply

The three options described in the previous sections have different consequences with respect to wiring and power supply. An example of a wiring diagram is given in FIG. 4.

Option one is an implementation in which the ‘Touch to Control’ box 123 is implemented in the media player. This option may require four wires to run down the media player, as the touch signals cannot be multiplexed without any additional processing operation. The grounds of the touch and audio signals may be combined. With options two and three, the resistance values may be multiplexed, so that only one wire may be needed to receive the control signals, similar to the Philips mobile remote control standard.

All of the three options need a power supply for skin resistance sensing. Power may be obtained from the player via the control line. If this harms the standard remote controls, a separate power line may be needed for option two, or a battery for option three. It is noted that the power supply requirement is dependent on the touch-sensing technology used. If another technology were used, e.g. buttons, this requirement might fall away.

Software: Creating Robust Behavior

To interpret the tapping on the earpieces 103, 111, and to safeguard from accidental control when they are not worn, some behavior is programmed in the player or in a separate interpretation unit. The player or unit converts the signals from the headset as described in Table 3 into commands such as play, pause, next song, etc. The player or unit may therefore comprise a state transition machine 126 for producing the behavior, see FIG. 6. In an example of such a state transition machine 126, the changes in the states of all touch sensors on the earpieces 103, 111 are interpreted and, subsequently, control events to the audio player are issued as specific sequences of state changes occur.

Touch Headphones

Six touch combinations may be discriminated by the headphones 103, 111. These six combinations are of particular interest to our application for the following reasons: (1) When one or both earpieces 103, 111 are not worn, control of the player should not be possible, to avoid accidental control when carrying the headphones in, for example, the pocket. Touching of the tapping areas does not need to be discriminated when the earpieces are not worn. Furthermore, wearing specifically the right or left earpiece is not discriminated in our application. Therefore we need only two states for these situations: NoneInEar and OneInEar. (2) As soon as the user has put on both earpieces, we need to discriminate which tap areas are being touched. There are four possibilities, hence four states: BothInEar_NoneTouched, BothInEar_LeftTouched, BothInEar_RightTouched, and BothInEar_BothTouched.

In the state transition diagram, the notation S=n is used to describe a transition to state n, with n ranging from 0 to 5 and indicating one of the six states described above. An example of mapping between n and the corresponding states is described in Table 4.

TABLE 4
Example of state numbers and descriptions

| State n | State name |
|---|---|
| 0 | None in-ear |
| 1 | One in-ear |
| 2 | Both in-ear + none touched |
| 3 | Both in-ear + left touched |
| 4 | Both in-ear + right touched |
| 5 | Both in-ear + both touched |

State Transition Machine

When the user starts using the headset by putting it on and touching the left and right earpieces 103, 111, various transitions occur between the states shown in. Table 4. These transitions may be translated into meaningful behavior of the audio player, which may be realized in a state transition machine 126.

At the highest level, the state transition machine 126 (STM) has two states, see FIG. 7. When the STM 126 is in state 128 labelled 2_NormalOperationMode, the tapping controls 104, 112, 119 on the headphone operate as described above. This is the situation when the earpieces 103, 111 are worn by the user, e.g. ready for playback of the music. The STM 126 is in state 127 labelled 1_InitialisationMode when one or both of the earpieces 103, 111 is not worn, or when the user is about to insert the earpieces 103, 111. In this case, the tapping controls 104, 112, 119 may be disabled to avoid accidental control of the audio player.

As soon as one or both of the earpieces 103, 111 is taken out, the STM 126 moves from state 128 2_NormalOperationMode to state 127 1_InitialisationMode, indicated by the arrow 129 with the label S=0 or 1. In state 127 1_InitialisationMode, any tapping on the tapping areas 119 of the headphones 103, 111 may be ignored, such that no playback controls are sent to the player in this state 127. To be able to inform the user about this, the transition 129 creates an “InputDisabledEvent”. This event may be processed, for example, by the audio player to generate a small audio signal to indicate the disabling 118 of the tapping controls 119.

State 127 1_InitialisationMode facilitates a safe way of putting on the earpieces 103, 111, without the player starting to jump around when touching the tapping areas 119.

When the user has finished putting on the earpieces 103, 111, the STM 126 makes a transition 130 to state 128 2_NormalOperationMode. With this transition 130, an “InputEnabledEvent” is generated. This may be used to inform the user that the tapping controls 119 are operable. Furthermore, a “HeadsetOnEvent” is generated. This event may be used by the player to start or resume playback of the music. The user may occasionally want to listen with only one earpiece 103, 111 inserted. Therefore, a “HeadsetOffEvent” may be issued only when both earpieces 103, 111 are taken out.

State 127 1_InitialisationMode

In a conventional remote control unit on a wire, there is often a mechanical hold switch to block operation of the controls when desired—for example, when carrying the player with the remote control in a bag or a pocket. Such a hold switch could be applied to the touch headphones as well, and would perhaps be desirable in certain situations. However, this would not be sufficient for our implementation of the touch headphones, as the user is likely to refit the earpieces 103, 111 in the ear, e.g. when they have fallen out partly after some movement. This may be relatively hard to do without touching the tapping areas 119, causing unwanted control events. In such a situation, it is unlikely that the user remembers to put the headphones 103, 111 on hold. Furthermore, the user might forget to block the controls 119 when taking the earpieces 103, 111 off. When, for example, the earpieces are subsequently put in a pocket, accidental control of the player is likely, possibly causing depletion of batteries. To avoid these drawbacks, the in-ear sensing areas 121, 122 were included on the headphones 103, 111, allowing enabling 109 and disabling 118 of the tapping controls 119, in addition to the pause-and-resume function when putting the headphones 103, 111 on and off.

In the 1_InitialisationMode state 127 it is ensured that the tapping controls 119 are not activated before the user has completed the process of putting on the earpieces 103, 111. This state 127 is needed as a safeguard against three types of unwanted events, related to the design of the in-ear headphones 103, 111 and the use of skin contacts or touch sensors:

1. When the earpieces 103, 111 are being put on, the user may hold them between his fingers and may touch the tap areas 119 due to the small form factor of in-ear type headphones 103, 111. As long as the earpieces 103, 111 are not inserted, the player should not react to this. However, also when it detects that both earpieces are on, the player should not immediately start reacting to the tap areas 119. While the user is still putting on the headset, the in-ear detection areas 121, 122 and also the tapping areas 119 may signal various on-off events, which easily result in unintended actions (e.g. raising volume, fast forward or backward, etc.). Enabling of the tapping controls 119 may be postponed until both earpieces 103, 111 have been inserted completely.

2. The automatic resumption of the playback function should not start before both earpieces 103, 111 are inserted completely for the same reason, to avoid an annoying fragmentation of playback with every on-off signal of the in-ear detection.

3. When the in-ear detection areas 121, 122 are somehow short-cut when the earpieces 103, 111 are carried in the user's pocket, this could start the automatic playback function of the player and drain the batteries. Otherwise, it could enable 109 the tapping controls 119 and then start playback when the tapping areas 119 would somehow be short-cut as well. It is possible to take extra precautions for this, by using the knowledge that the user is likely to hold the tapping areas 119 between his fingers when inserting the earpieces 103, 111.

When switching on the player, or when (one of) the earpieces 103, 111 (is) are taken out, the start state of 1_InitialisationMode 127 is entered. Start states are each indicated with a dot in the state diagrams in the Figures. Depending on the state of the touch headphone 103, 111, this will lead to one of the internal states of 1_InitialisationMode state 127, as shown in FIG. 8. When the touch headphone is not worm, the state 131 labeled BothPiecesOff is entered and a “HeadsetOffEvent” is triggered to inform the player about this status. In case the player was playing, it may be paused by the system 100.

As soon as the headphone 103, 111 is being put on, the system 100 starts traveling through the states 132, 133 OnePieceOff and BothPiecesOn. The state 133 BothPiecesOn refers to the situation where both earpieces 103, 111 are inserted and at least one of the tapping areas 119 is being touched. As soon as both earpieces 103, 111 are inserted and none of the tapping areas 119 is touched, the system 100 enters the state 134 BothPiecesOn_TouchingNone. The system 100 is likely to travel up and down through the states 131, 132, 133, 134 a couple of times, as the in-ear detection areas and tapping areas will probably give various on-off signals when the user is putting on and fitting both earpieces.

The moment the user has finished putting on the headphone is assumed to be the moment when both earpieces 103, 111 are on and the tapping areas 119 have not been touched for a while 110, 116, 117. In that case, a time-out will make the system 100 go to the end state 135 labeled “IsTimeOut” in FIG. 8. About one second appears to be a good value.

Via the end state 135, the system 100 finally leaves the 1_InitialisationMode state 126 and enters the 2_NormalOperationMode state 128, as shown in FIG. 7. During this transition 130, two events are triggered—“InputEnabledEvent” to inform the player that the headphones will now respond to tapping, and “HeadsetOnEvent” to automatically resume playback. It is only now that these events are triggered, to avoid the previously mentioned two issues.

The two arrows 136 in FIG. 8 relate to the issue of using the knowledge that the user is holding the tapping areas when inserting the earpieces. If the state transitions described by the two arrows 136 are not implemented, it would only be possible to reach the state 134 BothPiecesOn_TouchingNone by first passing the state 131 BothPiecesOn. In other words, it is necessary that at least one of the tapping areas 119 has been touched once when the earpieces 103, 111 are inserted. Thus, if the in-ear detection areas were, for example, short-cut in the user's pocket, the system 100 could never reach the end state 135, unless at least one of the tapping areas 119 would also be short-cut and then released as well. As such, the system 100 will not make the transition to the state 128 2_NormalOperationMode in FIG. 7, and neither trigger the events “InputEnabledEvent” and “HeadsetOnEvent”. This creates extra robustness withstanding playback starts via accidental short-cuts of the in-ear 121, 122 or tapping detection areas 119. Note, however, that this has a drawback. When the user manages to not touch the tapping areas 119 when inserting the earpieces 103, 111—for example, by holding the earpieces 103, 111 close to the wires during insertion—the user may need to provide an extra tap 113 to enable 109 the controls 119. This may be solved by enlarging the touch-sensitive tapping areas 119. The transition 137 from the start state to the state 134 BothPiecesOn_TouchingNone is useful to avoid the necessity of an extra tap when the user is already wearing the headphone 103, 111 while switching on the system 100.

State 128 2_NormalOperationMode

In the state 128 2_NormalOperationMode, the player should respond to the tapping 113 on the touch headphone 119. It is this state in which playback controls are generated as a result of the detected tapping patterns 113. Four types of tapping patterns are used for each earpiece 103, 111: a single tap, a double tap, a hold, and a tap-and-hold. Tapping patterns combining both earpieces 103, 111 have deliberately been avoided. This would probably become relatively complex for the user, and more importantly, there must be a safe way to put off the headphones 103, 111. We have reserved the pattern 113 of touching 119 both earpieces 103, 111 simultaneously, for taking out the earpieces 103, 111 safely without inducing any playback commands.

As shown in FIG. 9, the state 128 2_NormalOperationMode has internal states 138, 139, 140, 141. The system 100 always enters the state 138 NoneTouched via the start state, in which both earpieces 103, 111 are inserted and none of the tapping areas 119 is touched. This has to be the status of the headphone, as the system 100 can only come here via the state 134 BothPiecesOn_TouchingNone within state 127 1_IntialisationMode and the subsequent transition to state 128 2_NormalOperationMode, see FIGS. 7 and 8. When a tapping pattern 113 is started on the left or right earpiece 103, 111, this is dealt with in the state 140 2_1_LeftTouched or the state 139 2_2_RightTouched, respectively. When both earpieces 103, 111 are touched 119 simultaneously in either state, the system 100 always makes the transition to the state 141 BothTouched while triggering an “InputDisabledEvent”. This state 141 is only abandoned towards state 138 NoneTouched when both earpieces 103, 111 are released again, to allow recognition of new tapping sequences 113, or abandoned towards state 127 1_IntialisationMode when either earpiece 103, 111 is taken out, see FIG. 7, whichever happens first. In this way, it is possible to safely take off the headset.

When the system 100 is anywhere in state 140 2_1_LeftTouched, an S=4 event (both earpieces 103, 111 in ear and right earpiece touched) will immediately bring the system 100 to the state 139 2_2_RightTouched, and vice versa for an S=3 event in state 139 2_2_RightTouched. The same holds for an S=5 event in one of the sub-states 139, 140, which brings the system 100 immediately to the state 141 BothTouched. Any partially recognized tapping pattern 113 may be cancelled in these cases. This has the advantage of avoiding unexpected behavior, which may arise when alternating very fast between operating 113 the left earpiece 111 and operating the right earpiece 103. The player would not respond to any of the operations 113 in such a sequence. Only when a tapping pattern 113 is recognized completely, the corresponding event will be sent to the player. This is described in detail below.

States 2_1_LeftTouched and 2_2_RightTouched

The internals of the state 140 2_1_LeftTouched and the state 139 2_2_RightTouched actually handle the processing of the tapping patterns 113 to create the appropriate playback controls in the end. Four tapping patterns 113 need to be recognized for each earpiece: a ‘single tap’, a ‘double tap’, a ‘hold’, and a ‘tap-and-hold’, and should generate corresponding events used by the player to control the music playback. The implementation of the states 139, 140 2_1_LeftTouched and 2_2_RightTouched is symmetric: both recognize the same patterns and generate the same type of events, they only differ in the left 111 or the right earpiece 103 being tapped 113, see FIG. 10. To avoid duplication, the behavior of both states 139, 140 is described, only using the state 140 2_1_LeftTouched.

As shown in FIG. 9, the state 140 2_1_LeftTouched is entered via an S=3 event, caused with both earpieces 103, 111 in-ear and left earpiece 111 touched. This is the only entry to state 140 2_1_LeftTouched, such that entry of the start state within state 140 2_1_LeftTouched results in ending up in the state 142 LeftPressed. From here on, there are four different paths to the end state, each for recognizing one of the four tapping patterns:

1. If S=3 holds for some time and no other event comes in, a time-out labeled “300 msTimeOut” in FIG. 10 will bring the system 100 to the state 146 LeftHold, while issuing a “LeftHoldEvent” because a ‘hold’ has taken place. It appears that 300 milliseconds is a suitable value. Holding the left tapping area 119 longer results in repeatedly issuing the “LeftHoldEvent”, until it is released (S=2), by which the system 100 leaves the state 146 and returns to the state 138 NoneTouched in FIG. 9.

2. If the left tapping area 119 is released before the first time-out, thus only tapped for a short moment, the S=2 event brings the system 100 from state 142 LeftPressed to state 143 LeftReleased. A ‘single tap’ has taken place, but this is not yet communicated to the player, as a second tap or hold may still follow. Only when a time-out is triggered, the system 100 may be sure that no relevant headphone event follows, and a “LeftClickEvent” is triggered while leaving the state 143. If another S=3 event comes in before the time-out, the system 100 will move to state 144 LeftPressedSecond.

3. The transitions following from state 144 LeftPressedSecond are very similar to the transitions from state 143 LeftPressed: If a time-out occurs, the system 100 ends up in state 145 LeftExtHold while issuing an extended hold event, labeled “LeftExtHoldEvent”, which signals the player about a ‘tap-and-hold’ input 113. Repeated time-outs in the state 145 LeftExtHold each generate a “LeftExtHoldEvent”, until the tapping area 119 is released.

4. If an S=2 event comes in before the first time-out, a “LeftDoubleClickEvent” is issued to signal a ‘double-tap’ event to the player, and the state 144 is left.

Audio Player

The events generated by the state transition machine 126 finally need to result in the desired behavior of the audio player. The user actions 113 in the form of a tap, a double tap, a hold, and a tap-and-hold need to be mapped to the desired actions 106, 114 of the player, such as play, pause, next track, volume up and down, etc. The same holds for the automatic pause and resume function when taking off and putting on the headphones 103, 111.

The mapping of the tapping 113, 119 on the earpieces 103, 111 to actions 106, 114 of the player follows two user interface design rules: (1) frequently used functionality should be easily accessible, and (2) a value should be decreased by using the left earpiece 111 and increased by using the right earpiece 103. In accordance with these rules, an example mapping of the events resulting from the different tapping patterns 113 to the players deck and volume controls 106, 114 is given in Table 5.

TABLE 5
Example of mapping tapping patterns to deck and volume controls

| | Playback |
|---|---|
| Event from STM | control |
| “LeftClickEvent” OR “ HeadsetOffEvent” | Pause |
| “LeftDoucleClickEvent” | Previous track |
| “LeftHoldEvent” | Volume down |
| “LeftExtHoldEvent” | Fast rewind |
| “RightClickEvent” OR “HeadsetOnEvent” | Play (resume) |
| “RightDoucleClickEvent” | Next track |
| “RightHoldEvent” | Volume up |
| “RightExtHoldEvent” | Fast forward |

The playback controls described in Table 5 are common deck and volume controls for an audio player. The volume control and fast-forward and rewind functions are implemented through repeated events, as described above. The state transition machine 126 gives repeated hold and extended hold events when the tapping area 119 is held for a longer time. In this way, the volume will gradually increase or decrease—until the maximum or minimum is reached—the track will continuously wind forward (‘fast forward’) or backward (‘fast rewind’), respectively—until the end or the beginning.

It is proposed to resume playback as soon as the user puts on the headphone 103, 111. This will help to communicate that the earpieces 103, 111 are put in properly, and that the tapping controls 119 are enabled. As one can see in FIGS. 7 and 8, a “HeadsetOffEvent” is only generated when both earpieces 103, 111 are taken out. This makes listening to only one earpiece 103, 111 possible. When the user takes out one earpiece 103, 111, the music will continue playing. However, the tapping controls 119 will be disabled to avoid accidental actions, which is what the user would expect. The controls are enabled again if the user puts the earpiece 103, 111 back in.

Feedback on operating the areas 119 may be given via the touch headphones 103, 111 with audio signals, e.g. a short click for confirming an operation 113.

The touch headphones 103, 111 may be a separate unit that is compatible with existing standards for remote controls. In that case, the touch headphones may be used with any existing media player that can handle a remote control unit and complies with the standard. The state transition machine 126 may be implemented in hardware integrated in the headphones 103, 111, which then produces signals as described below in Table 6.

TABLE 6
Mapping of tapping patterns to deck and volume controls

| Event from STM | Resistor value |
|---|---|
| “LeftClickEvent” | 10 K Ohm pulse (toggle play/pause) |
| “LeftDoucleClickEvent” | 42 K Ohm pulse (previous track) |
| “LeftHoldEvent” | 143 K Ohm pulse (volume down) |
| “LeftExtHoldEvent” | 42 K Ohm continuous (fast rewind) |
| “RightClickEvent” | 10 K Ohm pulse (toggle play/pause) |
| “RightDoucleClickEvent” | 20 K Ohm pulse (next track) |
| “RightHoldEvent” | 75 K Ohm pulse (volume up) |
| “RightExtHoldEvent” | 20 K Ohm continuous (fast forward) |

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “have” or “comprise” and its conjugations does not exclude the presence of elements or steps other than those stated in a claim. Use of the article “a” or “an” preceding an element does not exclude the presence of a plurality of such elements. The invention can be implemented by means of hardware comprising several distinct elements, and by means of a suitably programmed computer. In the entertainment device claim enumerating several means, several of these means can be embodied by one and the same item of hardware. The mere fact that certain measures are recited in mutually different dependent claims does not indicate that a combination of these measures cannot be used to advantage.

A ‘computer program’ is to be understood to mean any software product stored on a computer-readable medium, such as a floppy disk, downloadable via a network, such as the Internet, or marketable in any other manner.

1. An audio entertainment system (100) comprising:
a set of earpieces (101) for transducing audio (102), with a first earpiece (103) having a first input means (104) for receiving input (113) to control (106) the transducing; and
a first detector (107) for detecting the first earpiece (103) being positioned (108) for transducing audio (102),
the audio entertainment system (100) being arranged to enable (109) control (106) with the first input means (104) only after a predetermined first period (110) in which the first earpiece (103) is detected, with the first detector (107), to be continuously positioned for transducing audio (102).

2. An audio entertainment system (100) as claimed in claim 1, the audio entertainment system (100) further comprising:
a second earpiece (111) having a second input means (112) for receiving input (113) to further control (114) the transducing; and
a second detector (115) for detecting the second earpiece (111) being positioned (108) for transducing audio (102),
the system (100) being further arranged to enable (109) control (106) and further control (114) only if in addition the second earpiece (111) is detected, with the second detector (115), to be positioned for transducing audio (102).

3. An audio entertainment system (100) as claimed in claim 2, the system (100) being further arranged to postpone enabling of the control action (106) and the further control action (114) until the second earpiece (111) has been detected, with the second detector (115), to be continuously positioned for transducing audio (102) for a predetermined second period (116).

4. An audio entertainment system (100) as claimed in claim 2, the system (100) being further arranged to postpone enabling of the control action (106) and the further control action (114) until both the first and the second input means (112) are simultaneously without input (113).

5. An audio entertainment system (100) as claimed in claim 2, the system (100) being further arranged to postpone enabling of the control action (106) and the further control action (114) until both the first and the second input means (112) have simultaneously been without input (113) for a predetermined third period (117).

6. An audio entertainment system (100) as claimed in claim 2, the system (100) being further arranged to disable (118) control (106) and further control (114) if both the first and the second input means (112) receive input (113) simultaneously.

7. An audio entertainment system (100) as claimed in claim 1, the system (100) being further arranged to disable (118) control (106) with the first input means (104) as soon as the first earpiece (103) is detected to be no longer positioned for transducing audio.

8. A method of transducing audio (102) by means of a set of earpieces (101) with a first earpiece (103) having a first input means (104) for controlling (106) the transducing, in which:
input (113) is given to the first input means (104); and
a first detector (107) detects the first earpiece (103) to be positioned for transducing audio, and
enabling the controlling control (106) with the first input means (104) only after a predetermined first period (110) in which the first detector (107) continuously detects the first earpiece (103) to be positioned for transducing audio (102).

9. A computer program product for use in an audio entertainment system (100), the audio entertainment system (100) comprising:
a set of earpieces (101) for transducing audio (102), with a first earpiece (103) having a first input (113) means for receiving input (113) to control (106) the transducing;
a processor for processing the input (113) to control (106) the transducing; and
a first detector (107) for detecting the first earpiece (103) being positioned (108) for transducing audio (102),
the computer program product being designed to instruct the processor to enable (109) control (106) with the first input means (104) only after a predetermined first period (110) in which the first earpiece (103) is detected, with the first detector (107), to be continuously positioned for transducing audio (102).
